(19) United States
(12) Patent Application Publication
(10) Pub. No.: US 2025/0253401 A1
(43) Pub. Date: Aug. 7, 2025

(54) BATTERY

(71) Applicant: TOYOTA JIDOSHA KABUSHIKI KAISHA, Toyota-shi (JP)

(72) Inventor: Kyosuke YOSHIDA, Susono-shi (JP)

(73) Assignee: TOYOTA JIDOSHA KABUSHIKI KAISHA, Toyota-shi (JP)

(21) Appl. No.: 19/037,823

(22) Filed: Jan. 27, 2025

(30) Foreign Application Priority Data
Feb. 6, 2024 (JP) 2024-016281

(51) Int. Cl. H01M 10/0568; H01M 4/02; H01M 4/38

(52) U.S. Cl. CPC H01M 10/0568; H01M 4/386; H01M 2004/021; H01M 2004/027; H01M 2300/0025

(57) ABSTRACT

It is an object of the present disclosure to provide a battery capable of suppressing peeling of an anode current collector. The above object is achieved by providing a battery comprising layers in an order of a cathode layer, an electrolyte layer including a liquid electrolyte, and an anode layer, wherein the anode layer includes an anode active material layer and an anode current collector from the electrolyte layer side, the anode active material layer includes a granulated particle containing a Si particle with a pore, an average particle size D₅₀ of the granulated particle is 5.5 μm or more and 7.2 μm or less, and the liquid electrolyte includes an ionic liquid.

### TECHNICAL FIELD

The present disclosure relates to a battery.

### BACKGROUND ART

In recent years, a lithium-ion secondary battery has been expected to use a Si based material for an anode active material in order to further increase the capacity. Patent Literature 1 discloses a battery system comprising an active material containing nanosilicon, a polyacrylonitrile polymer that binds the active material to conduct electricity and lithium ions, and an electrolyte that contacts the active material, the electrolyte comprising a LiFSI salt and an ionic liquid having an anionic of bis(fluorosulfonyl)imide (FSF).

### CITATION LIST

### Patent Literatures

Patent Literature 1: International Publication No. 2016-070120

### SUMMARY OF DISCLOSURE

### Technical Problem

An anode active material containing a Si based material (hereinafter, referred to as a Si based anode active material) has a high-theoretical capacity density, while having a large change in volume during charging and discharging. On the other hand, in the liquid-based battery, a SEI coating (Solid Electrolyte Interphase) is formed at the interface between the anode and the liquid electrolyte by reductive decomposition of the liquid electrolyte mainly during charge. In a liquid-based battery using the Si based anode active material, the SEI film is partially collapsed due to a volume change of the Si based anode active material during charging and discharging, the SEI film is reformed, and the collapsing and the reforming are repeated. As a result, the resistivity of the battery is increased with charging and discharging, and the capacitance is decreased due to Li depletion.

It is conceivable to use a Si particle with a pore (porous Si particle (p-Si particle)) in order to reduce the expansion and contraction of the Si based anode active material. However, p-Si particle has low interfacial adhesiveness due to their high specific surface area, and an anode current collector may be peeled off from the anode active material layer due to expansion and contraction. When the anode current collector is peeled off, the cycle characteristic is deteriorated.

The present disclosure has been made in view of the above circumstances, and an object of the present disclosure is to provide a battery capable of suppressing peeling of the anode current collector.

### Solution to Problem

[1]

A battery comprising layers in an order of a cathode layer, an electrolyte layer including a liquid electrolyte, and an anode layer, wherein
the anode layer includes an anode active material layer and an anode current collector from the electrolyte layer side,
the anode active material layer includes a granulated particle containing a Si particle with a pore,
an average particle size D₅₀ of the granulated particle is 5.5 μm or more and 7.2 μm or less, and
the liquid electrolyte includes an ionic liquid.

[2]

The battery according to [1], wherein
the liquid electrolyte further includes lithium bis(fluorosulfonyl)imide (LiFSI) as a Li salt,
the ionic liquid includes a bis(fluorosulfonyl)imide anion (FSI) as an anion moiety, and
a molar ratio of the Li salt to the ionic liquid (a molar number of the Li salt/a molar number of the ionic liquid) is ⅔ or more.

[3]

The battery according to [1] or [2], wherein an average particle size D₅₀ of the Si particle is 0.5 μm or more and 0.6 μm or less.

[4]

The battery according to any one of [1] to [3], wherein the granulated particle includes a polyvinylidene fluoride-hexafluoropropylene copolymer.

### Advantageous Effects of Disclosure

Battery according to the present disclosure can suppress peeling of the anode current collector.

### BRIEF DESCRIPTION OF DRAWINGS

FIG. 1 is a schematic cross-sectional view illustrating a battery of the present disclosure.

FIGS. 2A and 2B are images observation by SEM of granulated particles 1 and granulated particles 2 used in Example 1 and Example 2.

FIGS. 3A, 3B and 3C are charge-discharge curves of Comparative Example 1 and Comparative Example 2.

FIGS. 4A, 4B and 4C are charge-discharge curves, a Coulomb efficiency measurement result, and an impedance measurement result of Example 1.

FIGS. 5A, 5B and 5C are charge-discharge curves, Coulomb efficiency measurement result, and an impedance measurement result of Example 2.

FIGS. 6A and 6B are observational view of a battery of Reference Example and Comparative Example 1 at the first discharging and after cycles.

### DESCRIPTION OF EMBODIMENTS

Hereinafter, a battery according to an embodiment of the present disclosure will be described with reference to the drawings. Each of the drawings shown below is schematically shown, and the size and shape of each part are appropriately exaggerated for ease of understanding. In addition, in the present specification, when expressing a mode in which another member is disposed with respect to a certain member, when simply referred to as “above” or “below”, unless otherwise specified, it includes both a case in which another member is disposed directly above or directly below a certain member so as to be in contact with the certain member, and a case in which another member is disposed above or below a certain member via another member.

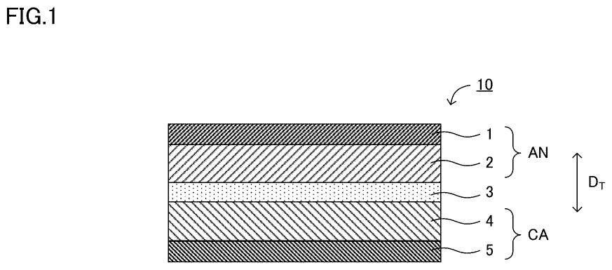

FIG. 1 is a schematic cross-sectional view illustrating a battery according to the present disclosure. Battery 10 shown in FIG. 1 includes an anode current collector 1, an anode active material layer 2, an electrolyte layer 3, a cathode active material layer 4, and a cathode current collector 5 in this order along the thickness Dr. An anode layer AN has the anode active material layer 2 and the anode current collector 1 from the electrolyte layer 3 side. A cathode layer CA has the cathode active material layer 4 and the cathode current collector 5. The anode active material layer 2 includes a granulated particle containing a Si particle with a pore (hereinafter, also referred to as a p-Si particle), and an average particle size of the granulated particle is within a predetermined range. In addition, in the present disclosure, the liquid electrolyte contained in the electrolyte layer includes an ionic liquid.

Since a p-Si particle has a large specific surface area, the particle has low interfacial adhesiveness with the anode current collector, and peel is likely to occur between the anode current collector and the anode active material layer due to expansion and contraction. In the present disclosure anode active material layer 2 includes a granulated particle obtained by granulating the p-Si particle, and the average particle size of the granulated particle is within a predetermined range. Therefore, since the specific surface area is reduced by granulation, peeling of the anode current collector 1 can be suppressed. In addition, although there is a concern about a decrease in ion conductivity due to an increase in the average particle size due to granulation, in the present disclosure, since the electrolyte penetrates between the granulated particles, a decrease in ion conductivity is suppressed.

### 1. Anode Layer

An anode layer includes an anode active material layer and an anode current collector.

### (1) Anode Active Material Layer

An anode active material layer has at least a granulated particle containing a Si particle with a pore. The anode active material layer may further contain at least one of a conductive material and a binder.

### (a) Granulated Particle

The granulated particle is granulated particle obtained by granulating a Si particle with a pore using, for example, a binder. An average particle size D₅₀ of the granulated particle is 5.5 μm or more and 7.2 μm or less. The average particle size D₅₀ refers to the cumulative 50% particle size (median size) of the cumulative particle size distribution and is calculated from, for example, measurements by laser diffractive particle size distribution analyzer or scanning electron microscopy (SEM). The granulated particle preferably contains a binder (binder for granulating). The granulated particle may not contain a conductive material.

The p-Si particle has a pore inside the primary particle. By having the pore, it is possible to suppress the volume change during charging and discharging. The porosity of the Si particle is not particularly limited, but is, for example, 5% or more and 50% or less. The porosity can be calculated, for example, by observing SEM images of the cross-section of the p-Si particle and using the following equation:

Porosity (%)=100×(pore area)/(particle area).

The p-Si particle preferably has a large number of pores having pore diameters of 100 nm or smaller. The pore volume P₁ of the pores having pore diameters of 100 nm or smaller is, for example, 0.1 cc/g or larger, and may be 0.2 cc/g or larger. On the other hand, the pore volume P₁ may be, for example, equal to or less than 0.5 cc/g and equal to or less than 0.45 cc/g. The pore volume in the present disclosure means an integrated pore volume, and can be determined, for example, by measuring BET.

The p-Si particle preferably has a large number of pores having pore diameters of 10 nm or smaller. The pore volume P₂ of the pores having pore diameters of 10 nm or smaller is, for example, 0.03 cc/g or larger, and may be 0.035 cc/g or larger. On the other hand, the pore volume P₂ may be, for example, equal to or less than 0.08 cc/g and equal to or less than 0.07 cc/g.

The p-Si particle may comprise crystal phase of the silicon clathrate type. Crystal phase of the silicon clathrate type may be a crystal phase of the silicon clathrate type I, or may be a crystal phase of the silicon clathrate type II. The p-Si particle may or may not have a diamond-type Si crystal phase.

The particle diameter and the like of the p-Si particle are not particularly limited as long as the p-Si particle has granular, but the average particle size D₅₀ may be, for example, 0.3 μm or more, may be 0.4 μm or more, or may be 0.5 μm or more. Meanwhile, the average particle size D₅₀ is, for example, 1.0 μm or less, may be 0.8 μm or less, or may be 0.6 μm or less.

The p-Si particle may have a predetermined BET specific surface area. The BET specific surface area of the p-Si particle is, for example, 20.0 m²/g or more, may be 25.0 m²/g or more, may be 30.0 m²/g or more, or may be 35.0 m²/g or more. On the other hand, the BET specific surface area of the p-Si particle, for example, 60.0 m²/g or less, may be 55.0 m²/g or less, may be 50.0 m²/g or less, 45.0 m²/g or less, it may be 40.0 m²/g or less. The BET specific surface area can be calculated from BET method using, for example, a pore distribution-measuring device.

Examples of the method for producing the p-si particle include a method of producing an alloy of Mg and Si (Mg—Si alloy) and then removing Mg from Mg—Si alloy. Mg—Si alloy is obtained, for example, by heating mixtures of Mg and Si. The ratio (Mg/Si) of Mg to Si is, for example, 1.0 or more, may be 1.5 or more, and may be 2.0 or more. Meanwhile, Mg/Si is, for example, 6.0 or less. As a method of removing Mg from Mg—Si alloy, for example, a method of changing Mg in Mg—Si alloy to MgO by heating Mg—Si alloy in an oxygen-containing inert-gas atmosphere, and then removing MgO with an acid-solution is exemplified. Acid solutions include, for example, aqueous solutions comprising hydrochloric acid (HCl) and hydrofluoric acid (HF).

Examples of the method for producing the p-Si particle include a method of producing an alloy of Li and Si (Li—Si alloy) and then removing Li from Li—Si alloy. Li—Si alloy is obtained, for example, by mixing Li and Si. The ratio (Li/Si) of Li to Si is, for example, 1.0 or more, may be 2.0 or more, may be 3.0 or more, or may be 4.0 or more. On the other hand, Li/Si is 8.0 or less, for example. Examples of a method of removing Li from Li—Si alloy include a method of reacting a Li—Si alloy with a Li extractant. Examples of Li extractant include alcohols such as methanol, ethanol, 1-propanol, 1-butanol, 1-pentanol, and 1-hexanol; and acids such as acetic acid, formic acid, propionic acid, and oxalic acid.

Further, as a method for producing the p-Si particle, for example, a method of producing an alloy of Mg and Si (Mg—Si alloy), then removing Mg from Mg—Si alloy, then producing an alloy (Li—Si alloy) of Si from which Mg has been removed and Li, and then removing Li from Li—Si alloy is exemplified.

The binder contained in the granulated particle (hereinafter, also referred to as a binder for granulating) can be appropriately selected from known binders used in, for example, a lithium-ion secondary battery. Examples thereof include butadiene rubber (BR), butylene rubber (IIR), acrylate butadiene rubber (ABR), styrene-butadiene rubber (SBR), polyvinylidene fluoride (PVdF), and polyvinylidene fluoride-co-hexafluoropropylene (PVdF-HFP). Among them, PVdF-HFP is preferable, and PVdF-HFP containing VDF in an 50 mol % or more and 95 mol % or less is more preferably. PVdF-HFP may be a block-copolymer or a random copolymer.

The ratio of the p-Si particles and the binder for granulating in the granulated particles is not particularly limited, but the binder for granulation may be, for example, 1 part by weight or more, 5 parts by weight or more, or 10 parts by weight or more with respect to 100 parts by weight of the p-Si particles. On the other hand, with respect to 100 parts by weight of the p-Si particles, the binder for granulating may be, for example, 30 parts by weight or less, 20 parts by weight or less, or 15 parts by weight or less. If the ratio of the binder for granulating is too large, the ratio of the Si active material may be relatively small, and the volume-energy-density may be lowered.

The granulated particle can be produced, for example, by mixing (granulating) the p-Si particle, the binder for granulating, solvents, and the like. The method of granulating is not particularly limited, and for example, a rolling granulation method, a fluidized bed granulation method, a stirring granulation method, a compressive granulation method, an extrusion granulation method, a crushing granulation method, a spray drying method (spray granulation method), or the like can be employed. It is preferable that a mixture (suspension) of the p-Si particle and the binder for granulating is granulated by a spray-drying method. In the spray drying method, the mixture is sprayed into a dry atmosphere. At this time, the particles contained in the droplets to be sprayed are granulated as a single lump. Therefore, the amount of solid content contained in the granulated particles varies depending on the size of the droplets, and the size and mass of the granulated particles vary. The droplets to be sprayed include, for example, the p-Si particle, the binder for granulating. The droplets to be sprayed may include, for example, a conductive material or a thickening material.

The proportion of the granulated particles contained in the anode active material layer is, for example, 40% by weight or more, may be 50% by weight or more, or may be 60% by weight or more. On the other hand, the ratio of the granulated particles contained in the anode layer is, for example, 95 wt % or less.

The anode active material layer has a plurality of granulated particles, and an electrolyte solution, which will be described later, usually permeates between the plurality of granulated particles.

The anode active material layer may contain a conductive material. Examples of the conductive material may include a carbon material, metal particles, conductive polymer. Examples of the carbon material include particulate carbon materials such as acetylene black (AB) and Ketjen black (KB), and fibrous carbon materials such as carbon fibers, carbon nanotubes (CNT), and carbon nanofibers (CNF).

The anode active material layer may contain a binder. Examples of the binder include a fluoride-based binder, a polyimide-based binder, and a rubber-based binder. The binder included in the anode active material layer may be the same as or different from the above-described binder for granulating.

The thickness of the anode active material layer is, for example, 0.1 μm or more and 1000 μm or less.

Examples of a method for forming the anode active material layer include a method in which a slurry for forming the anode active material layer containing at least the granulated particle is first prepared, and then the slurry for forming the anode active material layer is applied to a anode current collector and dried. In the present disclosure, it is preferable that the anode active material layer is not subjected to a pressing process for pressing the anode active material layer in the thickness direction. Examples of the pressing process include roller press and flat plate press. By not performing the pressing process, the filling ratio of the anode active material layer can be lowered, and when a high-concentration liquid electrolyte to be described later is used, unevenness in reaction can be suppressed, and the cycle characteristic is further improved. According to the present disclosure, it is possible to suppress the peeling of anode current collector by using the above-described granulated particles without performing the pressing process.

### (2) Anode Current Collector

An anode current collector is a layer for collecting current of anode active material layer. Examples of the anode current collector include metallic current collector. Examples of the metal current collector include current collector having a metal such as Cu, Ni. The metal current collector may be a single substance of the metal or an alloy of the metal. Examples of the form of anode current collector include a foil form.

### 2. Electrolyte Layer

The electrolyte layer includes a liquid electrolyte including an ionic liquid. The ionic liquid has a cationic portion and an anionic portion. Examples of the cation portion include organic nitrogen-based (imidazolium salt, ammonium salt, pyridinium salt, piperidinium salt, and the like), organic phosphorus-based (phosphonium salt, and the like), and organic sulfur-based (sulfonium salt, and the like). On the other hand, examples of the anion moiety include AlCl₄⁻, NO₂⁻, NO₃⁻, I⁻, BF₄⁻, PF₆⁻, SbF₆⁻, NbF₆⁻, F(HF) _{2. 3-}, CH₃CO₂⁻, CH₃SO₃⁻, CF₃SO₃⁻, (CF₃SO₂)₂N⁻, (FSO₂)₂N⁻ (bis(fluorosulfonyl)imide anion (FSI)). Among them, the ionic liquid preferably contains FSI as the anionic portion.

The liquid electrolyte preferably contains a Li salt. Examples of the Li salt include lithium bis(fluorosulfonyl)imide (LiFSI) and lithium bis(trifluoromethane) sulfonimide (LiTFSI), and among them, LiFSI is preferable.

When the liquid electrolyte includes a bis(fluorosulfonyl)imide anion (FSI) as the anionic portion of the ionic liquid and a lithium bis(fluorosulfonyl)imide (LiFSI) as the Li salt, a molar ratio of the Li salt to the ionic liquid (a molar number of the Li salt/a molar number of the ionic liquid) is preferably ⅔ or more. Such a liquid electrolyte containng ionic liquid with high lithium-ion densities tend to achieve high average coulombic efficiencies when combined with the anode containing Si. On the other hand, such a high-concentration liquid electrolyte is highly viscous, and therefore, when the filling ratio of the anode active material layer is high, uneven reaction is likely to occur. According to the present disclosure, by using the above-described granulated particle, it is unnecessary to perform a pressing process for suppressing the peeling of current collector, and thus it is possible to form the anode active material layer having a low filling ratio. Therefore, such a high-concentration liquid electrolyte can be preferably used.

The electrolyte layer may include a separator. The material of the separator may be an organic material or an inorganic material. Specific examples thereof include porous membranes such as polyethylene (PE), polypropylene (PP), cellulose, polyvinylidene fluoride, polyamide, and polyimide, nonwoven fabrics such as resinous nonwoven fabrics and glass-fiber nonwoven fabrics, and porous ceramic membranes. The separator may have a single-layer structure or a laminated structure.

### 3. Cathode Layer

### (1) Cathode Active Material Layer

A cathode active material layer contains at least a cathode active material. The cathode active material layer may further contain at least one of an electrolyte, a conductive material, and a binder.

Examples of the cathode active material may include an oxide active material. Examples of the oxide active material include a rock salt layered active material such as LiCoO₂, LiMnO₂, LiNiO₂, LiVO₂, LiNi_{1/3}CO_{1/3}Mn_{1/3}O₂, a spinel-type active material such as LiMn₂O₄, Li₄Ti₅O₁₂, Li(Ni_{0.5}Mn_{1.5})O₄, and an olivine-type active material such as LiFePO₄, LiMnPO₄, LiNiPO₄, LiCoPO₄.

Examples of the shapes of the cathode active material include particulate shapes. The average particle size D₅₀ of the cathode active material is not particularly limited, but may be, for example, 10 nm or more and 100 nm or more. Meanwhile, the average particle size D₅₀ of the cathode active material is, for example, 50 μm or less, and may be 20 μm or less.

The conductive material used for the cathode active material layer is the same as the content described in “1. Anode layer” above, and therefore the description thereof will be omitted. Examples of the electrolyte used in the cathode active material layer includes liquid electrolyte described in “2. Electrolyte layer”. Examples of the binder used in the cathode active material layer includes the binder described in “1. Anode”. The thickness of the cathode active material layer is, for example, 0.1 μm or more and 1000 μm or less.

### (2) Cathode Current Collector

A cathode current collector is a layer for collecting current of the cathode active material layer. Examples of a material for the cathode current collector may include SUS, aluminum, nickel, iron, titanium and carbon.

### 4. Battery

Battery of the present disclosure is typically a battery in which a metal-ion conducts between the cathode layer and the anode layer. Examples of such battery include lithium-ion battery. The battery is a solution battery in which the electrolyte layer contains a liquid electrolyte. The battery may be a non-aqueous liquid electrolyte battery using a liquid electrolyte in which a supporting salt (Li salt) is dissolved in a solvent (ionic liquid).

Also, the battery of the present disclosure may be a primary battery, and may be a secondary battery; among them, the secondary battery is preferable. This is because it may be charged and discharged repeatedly, and it is useful, for example, as an in-vehicle battery. The secondary battery also includes the primary battery use of the secondary battery (intended for initial charge only).

Also, the battery in the present disclosure may be a single-cell battery, and may be a stacked battery. The stacked battery may be a monopolar type stacked battery (stacked battery of the parallel connection type), and may be a bipolar type stacked battery (stacked battery of the series connection type). The battery may include a battery case which stores the anode layer, the cathode layer and the electrolyte layer, and the like. Specific examples of battery case include a coin-type, a flat plate type, a cylindrical type, and a laminated type.

Applications of the battery include, for example, power supplies for vehicles such as hybrid electric vehicle (HEV), plug-in hybrid electric vehicle (PHEV), battry electric vehicle (BEV), gasoline-powered vehicles, and diesel-powered vehicles. In particular, it is preferably used for a power supply for driving a hybrid electric vehicle (HEV), a plug-in hybrid electric vehicle (PHEV), or a battry electric vehicle (BEV). In addition, the battery may be used as a power source for a moving object (for example, a railroad, a ship, or an airplane) other than vehicles, or may be used as a power source for an electric appliance such as an information processing device.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### EXAMPLES

### Comparative Example 1

A half-cell including the following anode, counter electrode, and liquid electrolyte was prepared. An anode active material layer was formed by coating a slurry for forming an anode active material layer containing a np-Si (nanoporous Si) particle as an anode active material, a polyimide-based resin as a binder, Ketjen Black (KB) and a vapor-grown carbon fiber (VGCF) as a conductive material, in this order at a ratio of 82:12:5:1 (wt %), and a solvent on an anode current collector (Cu foil) and drying. Thus, an anode having the anode current collector and the anode active material layer was produced. The np-Si particle is a Si particle with a pore having an average particle size D₅₀ of 0.5 μm and a specific surface area of 50 m²/g.

Metal Li was used as the counter electrode.

As the liquid electrolyte, a liquid electrolyte obtained by dissolving a Li salt in an ionic liquid so that a molar ratio of the Li salt/the ionic liquid is ⅔ was used, using a LiFSI as the Li salt and a mixed solution of ethylmethylimidazolium bis(fluorosulfonyl)imide (EMIm-FSI) and methylpropylpyrrolidinium bis(fluorosulfonyl)imide (P13-FSI) as the ionic liquid.

### Comparative Example 2

A half-cell similar to that of Comparative Example 1 was prepared except that pc-Si (porous clathrate Si) was used as an anode active material. The pc-Si particle is porous clathrate particle with a pore having an average particle size D₅₀ of 0.6 μm and a specific surface area of 33 m²/g.

### Reference Example

A half-cell similar to that of Comparative Example 1 was prepared except that crystalline Si particle having no pores was used as the anode active material. The crystalline Si particle had an average particle size D₅₀ Of 2.6 μm and a specific surface area of 1 m²/g.

### Example 1

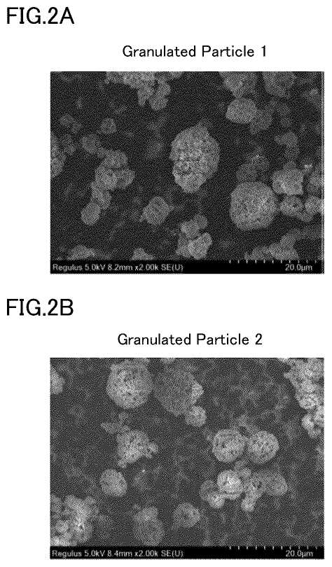

The np-Si particle used in Comparative Example 1 and a binder 1 for granulating were dispersed and dissolved in dimethylcarbonate so as to have a ratio (wt %) of np-Si particles: binder 1 for granulation=100:14 to obtain a slurry. The slurry was sprayed into a spray dryer in a nitrogen gas atmosphere at a temperature of 140° C. and dried. Thereby, granulated particles 1 was produced. As the binder 1 for granulating, a random copolymer having a molecular weight of 650,000 and containing VdF: HFP (a molar ratio)=89:11 was used. A SEM image of the obtained granulated particles 1 is shown in FIG. 2A. An average particle size D₅₀ of the granulated particle 1 was 7.2 μm. A half-cell similar to that of Comparative Example 1 was prepared except that the granulated particle 1 was used as anode active material.

### Example 2

The pc-Si particle used in Comparative Example 2 and a binder 2 for granulating were dispersed and dissolved in dimethylcarbonate so as to have a ratio (wt %) of pc-si particles: binder 2 for granulation=100:8 to obtain a slurry. The slurry was sprayed into a spray dryer in a nitrogen gas atmosphere at a temperature of 140° C. and dried. Thereby, granulated particle 2 was produced. As the binder 2 for granulating, a block copolymer having a molecular weight of 700,000 and containing VdF: HFP (a molar ratio)=90:10 was used. A SEM image of the obtained granulated particles 2 is shown in FIG. 2B. The average particle size D₅₀ of the granulated particle 2 was 5.5 μm. A half-cell similar to that of Comparative Example 1 was prepared, except that granulated particles 2 were used as an anode active material.

### [Calculation of 50-Cycle Average Coulomb Efficiency by Half-Cell]

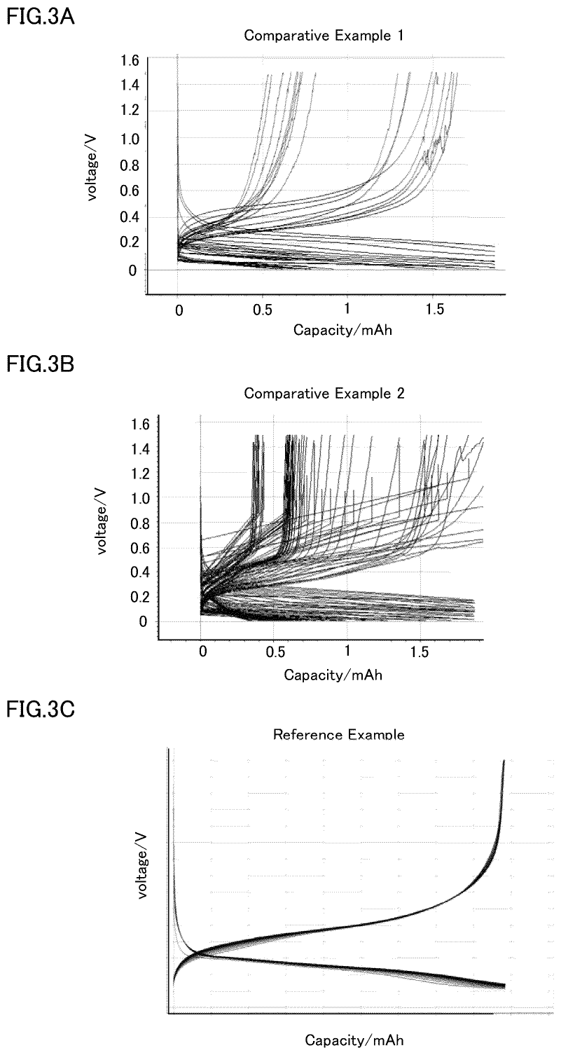

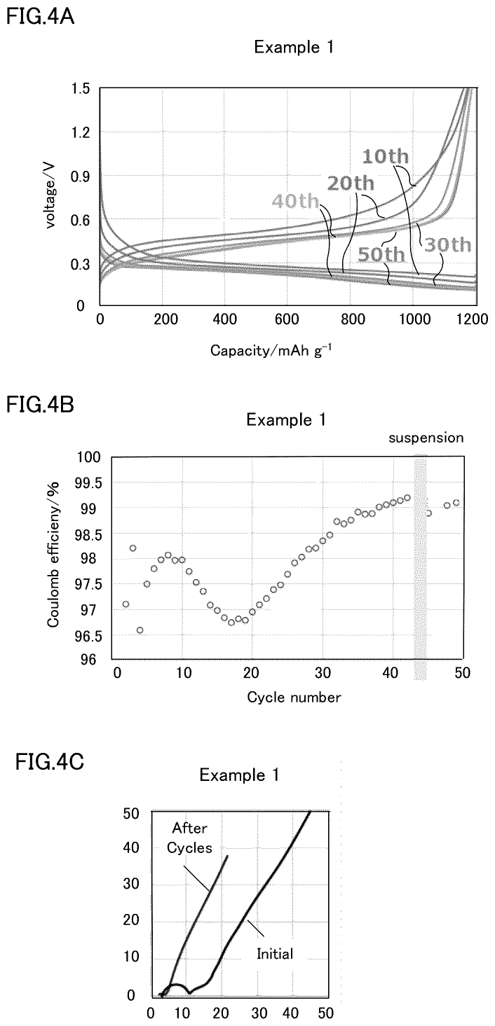

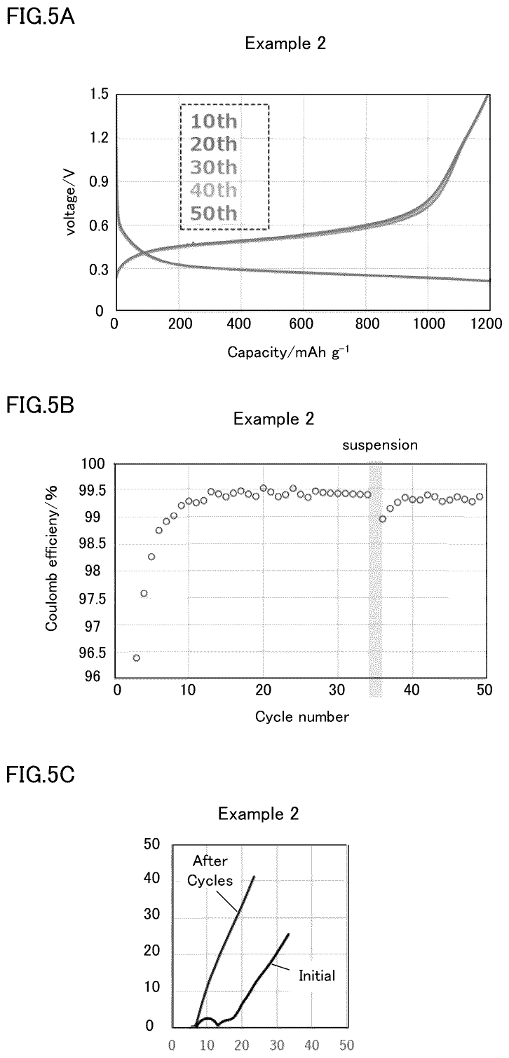

In each of Comparative Examples 1 to 2, Reference Example, and Examples 1 to 2, charging and discharging of the respective half-cells were performed for 50 cycles at 25° C. and 0.1 C with 1200 mAh/g as a charge capacity specification. The cutoff voltage (discharging) was set to 10 mV. The charge and discharge curve of Comparative Example 1, Comparative Example 2, Reference Example, Example 1 and Example 2, are respectively shown in FIG. 3A, FIG. 3B, FIG. 3C, FIG. 4A and FIG. 5A. In Comparative Example 1, the cut-off voltage was reached at the seventh cycle and in Comparative Example 2, the cut-off voltage was reached at the tenth cycle. This is presumed to be due to an increase in resistance caused by peeling of the current collector foil described later.

The Coulomb efficieny per cycle were calculated for each half-cell of Example 1 and Example 2. The results are shown in FIG. 4B and FIG. 5B.

Coulomb efficiency (%)=(discharge capacity/charge capacity)×100.

Table 1 shows the results of the coulombic efficiency of each of the half cells of Comparative Examples 1 to 2, Examples 1 to 2, and Reference Example immediately before reaching the cutoff (Comparative Examples 1 and 2) or after 50 cycles (Examples 1 and 2 and Reference Example). From Table 1, it was confirmed that the coulombic efficiency after cycles was improved as compared with that before granulation (Comparative Example 1 and Comparative Example 2).

TABLE 1

| | | Average | | Cycle |
|---|---|---|---|---|
| | Anode active | particle size | Reaching | Coulomb |
| | material | D₅₀ [μm] | Cut-off | Efficieny(%) |
| Comparative | np-Si | 0.5 | 7th cycle | 86.6 |
| Example 1 | | | | |
| Comparative | pc-Si | 0.6 | 10th cycle | 87.1 |
| Example 2 | | | | |
| Reference | crystalline Si | 2.6 | — | 99.5 |
| Example | | | | |
| Example 1 | granulated | 7.2 | — | 99.1 |
| | particle 1 | | | |
| Example 2 | granulated | 5.5 | — | 99.4 |
| | particle 2 | | | |

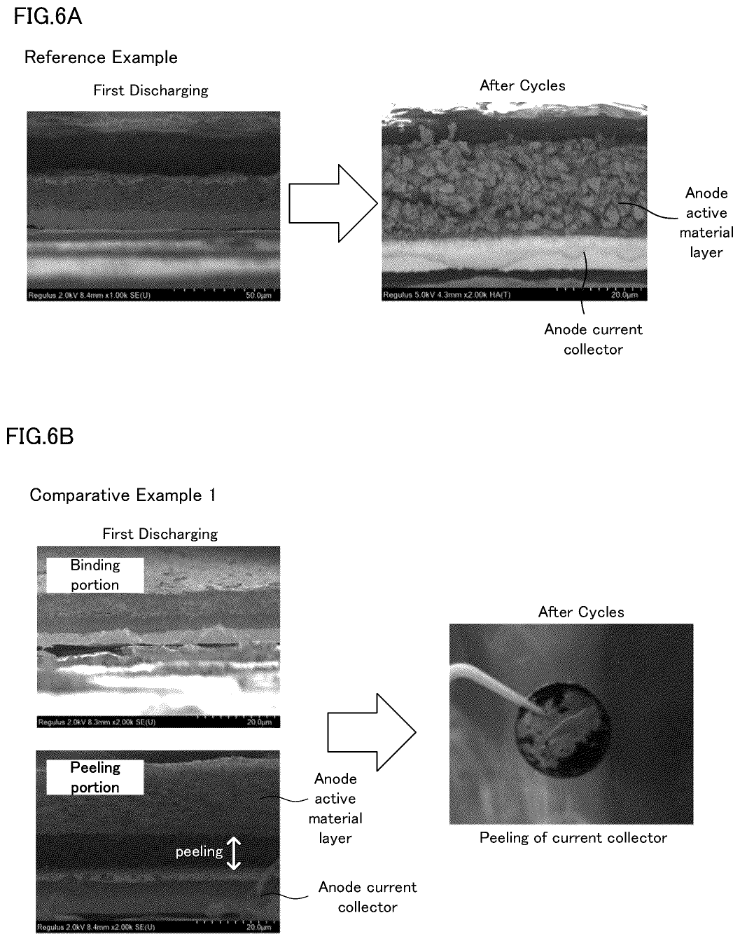

FIG. 6A shows a cross-sectional SEM image at the first discharging and after cycles of the Reference embodiment. FIG. 6B shows a cross-sectional SEM image of Comparative Example 1 at the first discharging and after cycles. As shown in FIG. 6A, in the Reference embodiment, the current collector foil and the anode active material layer were bound to each other even after cycles. On the other hand, as shown in FIG. 6B, in Comparative Example 1, the anode active material layer and the anode current collector were peeled off during the first discharging, and it was confirmed that the current collector foil was completely peeled off after cycles.

Impedance measurements were made on the battery (SOC=100%) of Example 1 and Example 2 at the initial of cycles and after cycles. The results of the impedance measurement (Nyquist plot) are shown in FIG. 4C and FIG. 5C. The horizontal axis represents a real component (resistance component) of the complex impedance. The vertical axis represents an imaginary component (capacitance component) of the complex impedance. Since there was no increase in the DC component (DC resistance), it was confirmed that the current collector foil was not peeled off.

### REFERENCE SIGNS LIST

1 . . . Anode current collector
2 . . . Anode active material layer
3 . . . Electrolyte layer
4 . . . Cathode active material layer
5 . . . Cathode current collector
10 . . . Battery

What is claimed is:

1. A battery comprising layers in an order of a cathode layer, an electrolyte layer including a liquid electrolyte, and an anode layer, wherein
the anode layer includes an anode active material layer and an anode current collector from the electrolyte layer side,
the anode active material layer includes a granulated particle containing a Si particle with a pore,
an average particle size D₅₀ of the granulated particle is 5.5 μm or more and 7.2 μm or less, and
the liquid electrolyte includes an ionic liquid.

2. The battery according to claim 1, wherein
the liquid electrolyte further includes lithium bis(fluorosulfonyl)imide (LiFSI) as a Li salt,
the ionic liquid includes a bis(fluorosulfonyl)imide anion (FSI) as an anion moiety, and
a molar ratio of the Li salt to the ionic liquid (a molar number of the Li salt/a molar number of the ionic liquid) is ⅔ or more.

3. The battery according to claim 1, wherein an average particle size D₅₀ of the Si particle is 0.5 μm or more and 0.6 μm or less.

4. The battery according to claim 1, wherein the granulated particle includes a polyvinylidene fluoride-hexafluoropropylene copolymer.
